(19) United States
(12) Patent Application Publication
(10) Pub. No.: US 2011/0137442 A1
(43) Pub. Date: Jun. 9, 2011

(54) Method for digitally copying parts of existing stringed musical instruments such as violins, violas, or cellos

(76) Inventors: John R. Waddle, Saint Paul, MN (US); Stephen M. Rossow, Saint Paul, MN (US); Steven A. Sirr, Golden Valley, MN (US)

(21) Appl. No.: 12/592,797

(22) Filed: Dec. 3, 2009

(51) Int. Cl. G05B 19/4097

(52) U.S. Cl. 700/98; 700/118; 700/159

(57) ABSTRACT

A process involving first obtaining X-ray Computed Tomography (CT) digital scans of existing stringed instruments. The images obtained from the scans are imported into a computer. Using a suitable software program, the digital scans are converted to Stereolithography (STL) files of the virtual object, which was scanned, such as parts of the existing stringed instruments. The digital STL files are imported into a computer, which is attached to a Computer Numerically Controlled (CNC) machine. Using a suitable software program, the CNC machine is programmed to carve the new parts of the scanned original stringed instruments. The resulting carved stringed instrument parts can be made into assembled new stringed instruments. The resulting assembled new instruments are accurate copies of the original stringed instruments that were scanned.

It is generally believed that the violin was invented by Andrea Amati, of Cremona, Italy, during the sixteenth century, and that the invention of the viola and cello followed soon after that of the violin. The exterior shape and the internal-cavity construction and arrangement of the violin, viola and cello have changed little since inception.

People who make violins, violas, and cellos are called luthiers. Luthiers of today are copyists of the general construction and arrangement of the early bowed string instruments. Most violins, violas and cellos being made today are copies of instruments made by the Amati family, the Guarneri family (which learned to make instruments from the Amati's), and the Stradivarius family (which was greatly influenced by the Amati's and the Guarneri's).

It is generally agreed that the violin was brought to its current state of perfection by two of the most famous luthiers of all time, Antonio Stradivari and Joseph Guarneri.

The traditional method for copying a violin, viola or cello (hereinafter called string instruments) involves first obtaining a template of the exterior outline of the body of an existing string instrument that is being copied. This is difficult. If any mistakes are made in this critical step of the process, the mistakes are magnified in each following step. A mold is then made from the template, usually by hand, while using simple hand tools, or possibly using a saw and sanding machines. Next, wood blocks (usually spruce or willow blocks) are attached to the mold, and the wood blocks are then carved and shaped, again usually by hand. Ribs (or the side members) are then made and attached to the shaped blocks. The top and back plates are then made, using the rib structure as the starting point. The luthier cuts out the top and back plates by hand, and carves the archings (complex curved shapes) using gouges, small planes and sharp scrapers. The inside curved surfaces and shapes of the top and back plates are also carved using gauges, small planes, and sharp scrapers. Correctly forming these shapes is crucial to the function, appearance, and acoustic properties of the finished instrument. Carving the tops and backs in this traditional way is very labor intensive, time consuming, and it is fraught with inaccuracy.

The present invention provides a non-invasive and non-destructive method of making string instruments (violins, violas, and cellos) wherein an original or master-made string instrument is copied in a manner that in no way affects the original or master-made instrument. Precise copying of the master-made instrument is the norm in our method, and we have invented a method or process to make wooden string instruments faster, and extremely accurate, more than has been possible using prior copying methods. Another advantage is the ability of up-scaling or down-scaling the instrument from the original if desired.

In accordance with this invention, an existing string instrument that is to be copied is non-invasively X-ray CT scanned in many hundreds of slices. For example, a Stradivarius violin will be scanned along its long axis with x-ray slices less than 1 mm thick. The CT scanner generates a single digital file, called DICOM (Digital Imaging and Communications in Medicine) for each sub-millimeter slice thickness.

The DICOM digital data provided by these CT scans is then imported into a radiology computer program and the DICOM images are converted into a single STL (stereo lithography) three-dimensional data file. The STL file is then used to run or control a Computer Numerical Control (CNC) machine, which operates to carve the parts, including the top, back, neck, and scroll members that, when assembled, comprise an extremely accurate copy of the master-made instrument. Because the data provided by the CT scans is digitized, and is accurate to less than 1/10 mm, the wooden templates, molds, tops, and backs made using the method of this invention are much more accurate than copies made by prior copying methods.

The present invention is also useful because, instead of laboriously carving the string instrument templates, molds, tops, backs, necks, and scrolls by hand, our new method requires much less time and therefore increases productivity. Because this method produces near perfect representations of the original stringed instrument, the quality of the finished copy-product is higher than hand produced.

In addition, our invention results in data that can be used any number of times, to produce many accurate copies of the existing string instrument. This precise repeatability is difficult to provide using only traditional methods of the luthier.

Briefly stated, our invention provides for the precise copying of string instruments (violins, violas and cellos) using an X-ray CT scanner and the resultant DICOM image files, an STL file generated from the DICOM image files, and a CNC machine which read the STL file, the result of which is an extremely accurate reproduction of the original stringed instrument CT scanned. The final product is a precise copy, which is made from various woods.

While X-ray CT technology has been used before in the medical industry to image the human body, and has been used by doctors to make models, such as bones, X-ray CT scanning and CNC machines have not been used before in combination to make accurate copies of the individual parts of string instruments. These parts are used to be made into a very high quality copy of the original stringed instrument.

It is believed that the exterior (outside) surfaces of the tops and backs of string instruments have been scanned using laser technology, or have been probed by CNC machines. These data files have been used to create the external shapes of these surfaces. Since these methods provide only external data, no information relative to topography of the interior surfaces can be reproduced.

The present invention is significantly different and an improvement upon the above-mentioned methods because both laser and probing techniques can scan only the outside surface of a hollow object, and do not provide information as to the object's internal cavity, whereas CT scanning in accordance with this invention provides data that defines, in three dimensions, all of the individual parts of the string instrument. This invention provides both the outside surfaces and inside surfaces (the inside cavity surfaces) of the original instrument's top and back.

Also, with both the laser method and the probing method, certain parts of the string instrument cannot be determined without the invasive removal of the fingerboard, strings, bridge and tailpiece. CT scanning can be done non-invasively and the entire string instrument is digitized.

Owners of extremely valuable string instruments are not usually willing to submit their instruments to anyone who is going to alter the instrument in any way. CT scanning has been proven to provide be a safe and non-invasive method of obtaining digital spatial data.

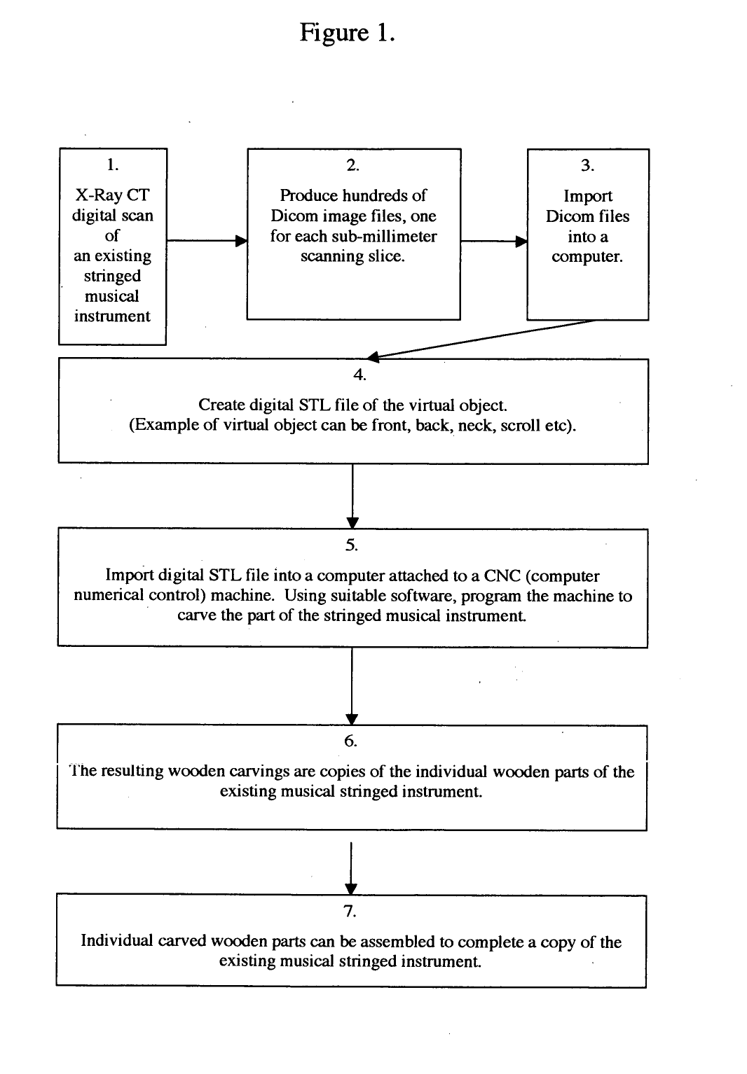

With reference to FIG. 1, this figure shows a violin (10) having a longitudinal axis (11) that extends perpendicular to the vertical x and y planes defined by the CT scanning cavity (12).

FIG. 2 provides a flow-chart-like showing of the present invention. In step or function box 20 an existing string instrument, such as violin (10 of FIG. 1), is scanned by an X-ray CT scanner (12 of FIG. 1). As a result, and as shown by function box 21, hundreds of DICOM data files are produced by CT scanner 12. For example, many hundreds of DICOM data files are produced for each CT scan, wherein each scan comprise a CT-picture of violin 10, each scan being less than 1 mm apart, and each scan being taken perpendicular to the axis 11 of violin 10.

In function box of FIG. 2, the many DICOM files provided by box 21 are imported to a computer such as a MacBook Pro computer whereat an STL file of the virtual object (the individual members of violin 10) is created, as shown by box 23. As a feature of this invention, a function box 24 may be provided to use radiology software to create a virtual violin that is representative of violin 10.

Function box 25 of FIG. 2 shows that the STL files provided by box 23 are provided or imported to a CNC machine wherein, using a 3D drafting program such as Rhinoceros, the router of the CNC machine is directed to move to form a wood member into a three dimensional shape as defined by the STL file, as is defined by functional box 26 of FIG. 2.

In functional box 27 of FIG. 2 the carvings of box 26 are assembled into a violin that is a copy of FIG. 1's violin 10.

1. What is claimed is a method for digital copying of parts of existing stringed musical instruments such as violins, violas, or cellos comprising the steps of:
a. providing said existing stringed musical instrument such as a violin, viola, or cello, and
b. scanning said musical instrument in a Computed Tomography (CT) scanner, producing Digital Imaging and Communications in Medicine (Dicom) images of at least one exterior surface and at least one interior surface, and
c. importing said Dicom images into a suitable computer, such as a macbook pro and
d. using radiology software, such as Osirix, create a digital virtual stringed instrument file in stereolithograpy (STL) format, and
e. import said STL digital file into 3D drafting program such as Rhinoceros, and
f. using said STL file, program Computer Numerical Control (CNC) machine to carve at least one surface of at least one separate part such as a top, back, neck, or scroll of said existing stringed musical instruments, and
whereby said new musical instrument carved parts will be exact copies of parts of said existing musical instruments.
